(19) United States
(12) Patent Application Publication
(10) Pub. No.: US 2026/0331926 A1
(43) Pub. Date: Oct. 22, 2026

(54) ELECTRONIC APPARATUS, CONTROL METHOD, AND STORAGE MEDIUM

(71) Applicant: CASIO COMPUTER CO., LTD., Tokyo (JP)

(72) Inventor: Kento KITAMURA, Tokyo (JP)

(73) Assignee: CASIO COMPUTER CO., LTD., Tokyo (JP)

(21) Appl. No.: 19/651,613

(22) Filed: Apr. 18, 2026

(30) Foreign Application Priority Data
Apr. 21, 2025 (JP) 2025-069331

(51) Int. Cl. H02J 7/35; H02J 7/34; H02J 7/96

(52) U.S. Cl. CPC H02J 7/35; H02J 7/345; H02J 7/96; H02J 2207/50

(57) ABSTRACT

An electronic apparatus includes an electric double-layer capacitor and at least one processor that, in response to the capacitor being charged in a first charging mode where a self-discharge amount of the capacitor per unit time after start of self-discharge that is performed after a voltage of the capacitor reaches a predetermined voltage by the capacitor being charged is smaller than a predetermined threshold value, performs a predetermined process in a first mode with electric power supplied from the capacitor, and in response to the capacitor being charged in a second charging mode where the self-discharge amount of the capacitor per unit time after the start of the self-discharge is equal to or larger than the threshold value, performs the process in a second mode where current consumption in performing the process is smaller than current consumption therein in the first mode with the power supplied from the capacitor.

### CROSS-REFERENCE TO RELATED APPLICATION

This application is based upon and claims the benefit of priority from the prior Japanese Patent Application No. 2025-069331, filed on Apr. 21, 2025, the entire contents of which are incorporated herein by reference.

### BACKGROUND OF THE INVENTION

### Technical Field

The present disclosure relates to an electronic apparatus, a control method, and a storage medium.

### Description of Related Art

JP 2000-208379 A and JP 2000-100672 A describe a technique for suppressing self-discharge of an electric double-layer capacitor used, in an electronic apparatus, as a power supply in place of a primary cell.

### SUMMARY OF THE INVENTION

According to an aspect of the present disclosure, there is provided an electronic apparatus including:
an electric double-layer capacitor as a battery; and
at least one processor that,
in response to the electric double-layer capacitor being charged in a first charging mode in which a self-discharge amount of the electric double-layer capacitor per unit time after start of self-discharge that is performed after a voltage of the electric double-layer capacitor reaches a predetermined voltage by the electric double-layer capacitor being charged is smaller than a predetermined threshold value, performs a predetermined process in a first mode with electric power supplied from the electric double-layer capacitor, and
in response to the electric double-layer capacitor being charged in a second charging mode in which the self-discharge amount of the electric double-layer capacitor per unit time after the start of the self-discharge that is performed after the voltage of the electric double-layer capacitor reaches the predetermined voltage by the electric double-layer capacitor being charged is equal to or larger than the threshold value, performs the predetermined process in a second mode in which current consumption in performing the predetermined process is smaller than current consumption therein in the first mode with the electric power supplied from the electric double-layer capacitor.

### BRIEF DESCRIPTION OF DRAWINGS

FIG. 1 is a plan view illustrating an external configuration of a calculator (electronic apparatus) according to an embodiment of the present disclosure.

FIG. 2 is a block diagram illustrating a functional configuration of the calculator.

FIG. 3 is a schematic circuit diagram illustrating a schematic configuration of a power supply.

FIG. 4 is a flowchart illustrating a mode determination process.

FIG. 5 illustrates examples of voltage change over time in an electric double-layer capacitor due to its self-discharge.

FIG. 6 is a flowchart illustrating a mode control process.

### DETAILED DESCRIPTION

Hereinafter, an embodiment of an electronic apparatus according to the present disclosure will be described with reference to the drawings. Although various limitations technically preferable for carrying out the present disclosure are imposed on the embodiment described below, the scope of the present disclosure is not limited to the embodiment or illustrated examples.

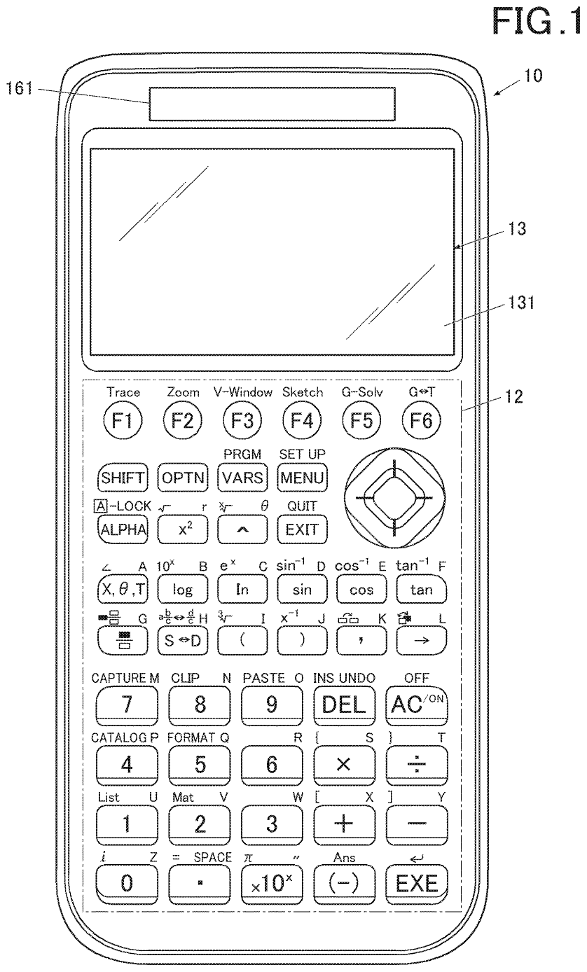

As illustrated in FIG. 1, a calculator 10 is, what is called, a scientific calculator capable of performing mathematical operations of calculation formulas (mathematical expressions), which include functions. As illustrated in FIG. 1, the calculator 10 includes a key inputter 12 having various groups of keys, a display 13, and a solar cell 161. The key inputter 12 is a group of keys for receiving, from a user, operations to input elements of a calculation formula, such as numerical values and operators, and for receiving operations to make instructions to perform various processes, and includes keys to each of which a unique function is assigned. The display 13 includes a liquid crystal display 131 or the like. The display 13 displays various types of data, such as numerical values, characters, signs, symbols, mathematical expressions, and mathematical operations'results, in accordance with operations on the key inputter 12. The solar cell 161 generates electromotive force by a photoelectric effect in response to incidence of ambient light, such as sunlight, light from a fluorescent lamp or light from an incandescent lamp. The solar cell 161 is provided at a position on which ambient light is incident in the calculator 10, for example, on the front surface where the key inputter 12 and the display 13 are provided. The electromotive force generated by the solar cell 161 is larger as the luminance of the incident ambient light is higher.

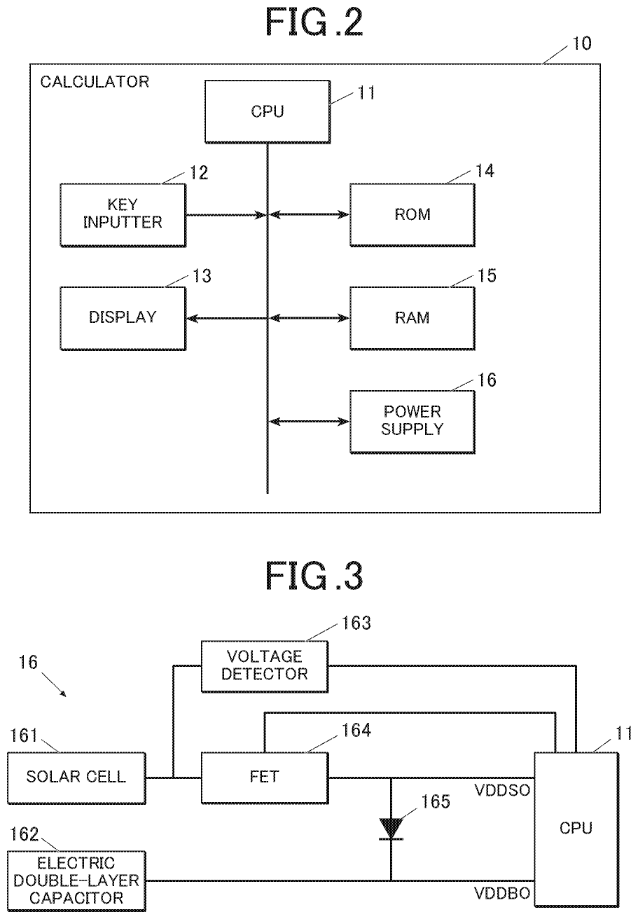

As illustrated in FIG. 2, the calculator 10 includes a central processing unit (CPU) 11, the key inputter 12 described above, the display 13 described above, a read only memory (ROM) 14, a random access memory (RAM) 15, and a power supply 16. The CPU 11 is a controller (processor) that controls the components of the calculator 10 and performs a predetermined process in accordance with a user operation. The CPU 11 reads a specified program among various programs stored in the ROM 14, loads the read program into the RAM 15, and performs a process among various processes in cooperation with the loaded program. The key inputter 12 includes various keys, and receives operations input by the user pressing the various keys and outputs operation signals to the CPU 11. The CPU 11 performs various processes based on the operation signals corresponding to the operations input by the user pressing the key inputter 12. The display 13 displays various types of information on its display screen under the control of the CPU 11. The ROM 14 stores various programs, data used for various processes, and so forth. The ROM 14 stores programs corresponding to various functions of the calculator 10. The RAM 15 is a volatile semiconductor memory from which information can be read and to which information can be written. The RAM 15 provides a work area for the CPU 11 and temporarily stores data generated by a predetermined process so as to be writable from the CPU 11, the predetermined process being performed in accordance with a user operation in a function among various functions of the calculator 10.

As illustrated in FIG. 3, the power supply 16 includes the solar cell 161 described above, an electric double-layer capacitor 162, a voltage detector 163, a field effect transistor (FET) 164, and a diode 165. Electric power generated by the solar cell 161 is input to the CPU 11 from a power-supply voltage input terminal VDDSO via the FET 164 that is in an ON state. Electric power output from the electric double-layer capacitor 162 is input to the CPU 11 from a power-supply voltage input terminal VDDBO. The CPU 11 supplies the electric power generated by the solar cell 161 or the electric power output from the electric double-layer capacitor 162 to the components of the calculator 10 to cause the components to operate.

The voltage detector 163 is connected to the solar cell 161, and detects the voltage of the electric power generated by the solar cell 161 and outputs the detection result to the CPU 11. The FET 164 is switched between the ON state and the OFF state by command signals output from the CPU 11. In the case where the FET 164 is in the ON state, the electric power generated by the solar cell 161 is supplied to the CPU 11 via the FET 164, and also supplied to the electric double-layer capacitor 162 via the FET 164 and the diode 165 so that the electric double-layer capacitor is charged. In the case where the FET 164 is in the OFF state, no electric power is supplied from the solar cell 161 to either the CPU 11 or the electric double-layer capacitor 162. The diode 165 is connected between the solar cell 161 and the electric double-layer capacitor 162, and functions as a reverse-current blocking element that prevents an electric current from flowing from the electric double-layer capacitor 162 to the solar cell 161. Therefore, while electric power is being generated by the solar cell 161, the electric double-layer capacitor 162 can be charged with the electric power generated by the solar cell 161, whereas while no electric power is being generated by the solar cell 161, an electric current can be prevented from flowing from the electric double-layer capacitor 162 to the solar cell 161.

Next, operation of the calculator 10 will be described. The calculator 10 can operate in two power-supply modes, namely, a normal mode as a first mode and a low-consumption mode as a second mode. The low-consumption mode is a mode in which the operating frequency of the CPU 11 is reduced to be lower than that in the normal mode in order to reduce current consumption in the calculator 10, and accordingly the speed of a calculation process that is performed in accordance with a user operation via the key inputter 12 is reduced to be lower than that in the normal mode, or a mode in which display (display process) is performed on the liquid crystal display 131 with a smaller number of gradation levels (e.g., two gradation levels) than that in the normal mode. The normal mode is a mode in which the speed of the calculation process is higher than that in the low-consumption mode and a mode in which display is performed on the liquid crystal display 131 with a larger number of gradation levels (e.g., four gradation levels) than that in the low-consumption mode.

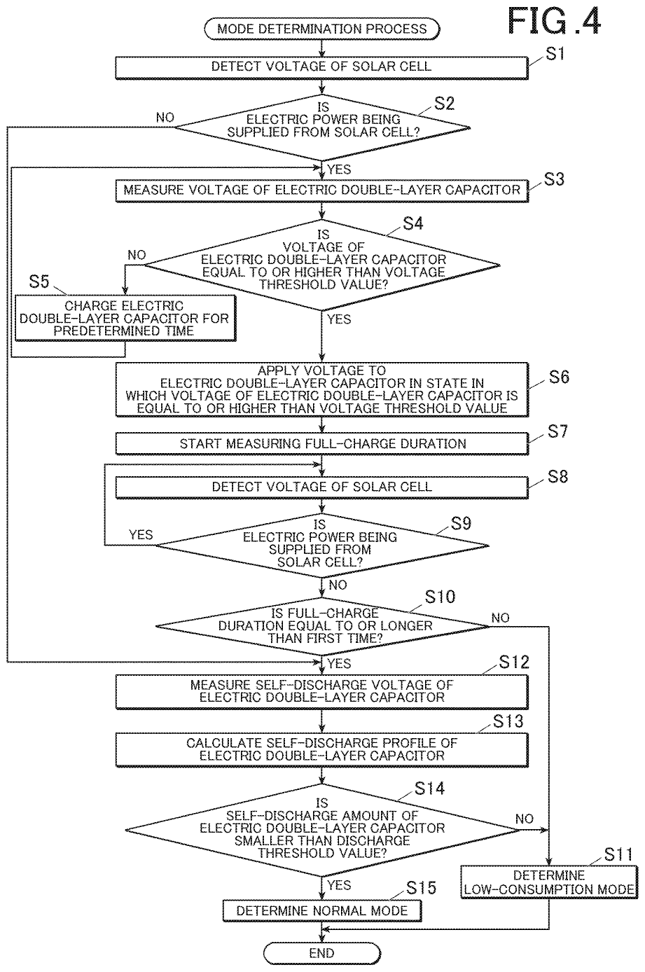

A mode determination process illustrated in FIG. 4 is performed by the CPU 11 of the calculator 10 that is in a power-on state. By performing the mode determination process, the CPU 11 determines the power-supply mode of the calculator 10 for a predetermined process. Examples of the predetermined process include the calculation process in accordance with a user operation via the key inputter 12 and the display process on the liquid crystal display 131. At the start of the mode determination process, the FET 164 is in the ON state.

In the mode determination process, first, the CPU 11 detects, with the voltage detector 163, the voltage of the electric power generated by the solar cell 161 (Step S1). Next, the CPU 11 determines whether the voltage of the electric power, which is generated by the solar cell 161, detected by the voltage detector 163 in Step S1 is equal to or higher than a predetermined voltage, in other words, whether electric power is being supplied from the solar cell 161 (Step S2). If the CPU 11 determines that electric power is being supplied from the solar cell 161 (Step S2; YES), the CPU 11 puts the FET 164 in the OFF state by outputting a command signal to the FET 164, and measures the voltage at the power-supply voltage input terminal VDDBO. Thus, the CPU 11 measures the voltage of the electric double-layer capacitor 162 (Step S3). Next, the CPU 11 determines whether the voltage of the electric double-layer capacitor 162 measured in Step S3 is equal to or higher than a predetermined voltage threshold value (e.g., the voltage of the electric double-layer capacitor 162 in a fully charged state) (Step S4). If the CPU determines that the voltage of the electric double-layer capacitor 162 is lower than the voltage threshold value (Step S4; NO), the CPU 11 puts the FET 164 in the ON state by outputting a command signal to the FET 164, and supplies the electric power generated by the solar cell 161 to the electric double-layer capacitor 162 to charge the electric double-layer capacitor 162 for a predetermined time (Step S5), and then returns the mode determination process to Step S3.

If the CPU 11 determines that the voltage of the electric double-layer capacitor 162 is equal to or higher than the voltage threshold value (Step S4; YES), the CPU 11 puts the FET 164 in the ON state by outputting a command signal to the FET 164, and supplies the electric power generated by the solar cell 161 to the electric double-layer capacitor 162 to keep applying the voltage to the electric double-layer capacitor 162 in the state in which the voltage of the electric double-layer capacitor 162 is equal to or higher than the voltage threshold value (Step S6). Then, the CPU 11 starts measuring a full-charge duration of the electric double-layer capacitor 162 (in the case where the predetermined voltage threshold value is the voltage of the electric double-layer capacitor 162 in the fully charged state) (Step S7). The full-charge duration of the electric double-layer capacitor 162 is a time for which a voltage keeps being applied to the electric double-layer capacitor 162 in the state in which the voltage of the electric double-layer capacitor 162 is equal to or higher than the voltage threshold value.

Next, the CPU 11 performs Step S8 and Step S9 that are the same as Step S1 and Step S2, respectively. If the CPU 11 determines based on the detection result of the voltage detector 163 in Step S8 that electric power is being supplied from the solar cell 161 (Step S9; YES), the CPU 11 returns the mode determination process to Step S8.

If the CPU 11 determines that electric power is no longer supplied from the solar cell 161 (Step S9; NO), that is, a voltage is no longer applied to the electric double-layer capacitor 162, the CPU 11 stops measuring the full-charge duration, whose measurement was started in Step S7, and determines whether the measured full-charge duration is equal to or longer than a predetermined first time (e.g., one hour) (Step S10).

If the CPU 11 determines that the full-charge duration is shorter than the predetermined first time (Step S10; NO), the CPU 11 determines the low-consumption mode as the power-supply mode of the calculator 10 for the predetermined process (Step S11) and then ends the mode determination process.

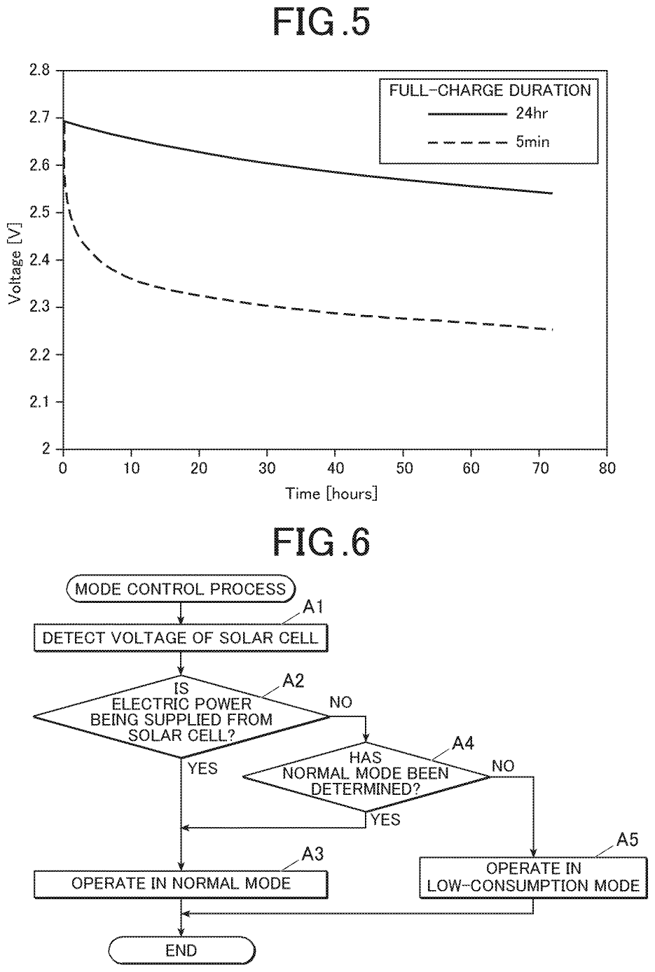

FIG. 5 illustrates examples of voltage change over time in the electric double-layer capacitor 162 due to its self-discharge in a case where the full-charge duration of the electric double-layer capacitor 162 is 24 hours and in a case where the full-charge duration of the electric double-layer capacitor 162 is five minutes. In the case where the full-charge duration is five minutes, immediately after the start of the self-discharge of the electric double-layer capacitor 162, the voltage steeply decreases because the amount of the self-discharge (which is hereinafter referred to as “self-discharge amount”) is large, as compared with the case where the full-charge duration is 24 hours. Thus, due to characteristics of the electric double-layer capacitor 162, in the case where the full-charge duration of the electric double-layer capacitor 162 is shorter than the predetermined first time, the self-discharge amount immediately after the start of the self-discharge is larger than that in the case where the full-charge duration is equal to or longer than the first time. Therefore, the continuous usable time of the calculator 10 may decrease. However, in the present embodiment, in this case, the power-supply mode of the calculator 10 is set to the low-consumption mode to reduce the current consumption in the calculator 10. This can suppress the decrease in the continuous usable time of the calculator 10.

Thus, the case where the full-charge duration is shorter than the predetermined first time (Step S10; NO) is a case where the electric double-layer capacitor 162 is charged in a second charging mode in which the self-discharge amount of the electric double-layer capacitor 162 per unit time after the start of its self-discharge that is performed after the voltage of the electric double-layer capacitor 162 reaches a predetermined voltage (voltage threshold value) by the electric double-layer capacitor 162 being charged is equal to or larger than a predetermined threshold value. The second charging mode is a charging mode in which the self-discharge amount of the electric double-layer capacitor 162 at a timing at which a predetermined time elapses from the start of the self-discharge that is performed after the voltage of the electric double-layer capacitor 162 reaches the predetermined voltage (voltage threshold value) by the electric double-layer capacitor 162 being charged is equal to or larger than the predetermined first value.

If the CPU 11 determines that the full-charge duration is equal to or longer than the predetermined first time (Step S10; YES), the CPU 11 puts the FET 164 in the OFF state by outputting a command signal to the FET 164, and measures the voltage of the power-supply voltage input terminal VDDBO. Thus, the CPU 11 measures the self-discharge voltage of the electric double-layer capacitor 162 (Step S12). Next, the CPU 11 calculates a self-discharge profile indicating voltage change over time in the electric double-layer capacitor 162 based on the full-charge duration of the electric double-layer capacitor 162, the self-discharge voltage of the electric double-layer capacitor 162 measured in Step S12, and the average value of the power consumption in the calculator 10 (Step S13).

Next, the CPU 11 determines whether, in the self-discharge profile indicating voltage change over time in the electric double-layer capacitor 162 calculated in Step S13, the self-discharge amount of the electric double-layer capacitor 162 at the timing at which the predetermined time elapses from the start of the self-discharge is smaller than a predetermined discharge threshold value (Step S14). If the CPU 11 determines that the self-discharge amount of the electric double-layer capacitor 162 is smaller than the discharge threshold value (Step S14; YES), the CPU 11 determines the normal mode as the power-supply mode of the calculator 10 for the predetermined process (Step S15) and then ends the mode determination process.

Thus, the case where the full-charge duration is equal to or longer than the predetermined first time (Step S10; YES) is a case where the electric double-layer capacitor 162 is charged in a first charging mode in which the self-discharge amount of the electric double-layer capacitor 162 per unit time after the start of its self-discharge that is performed after the voltage of the electric double-layer capacitor 162 reaches the predetermined voltage (voltage threshold value) by the electric double-layer capacitor 162 being charged is smaller than the predetermined threshold value. The first charging mode is a charging mode in which the self-discharge amount of the electric double-layer capacitor 162 at the timing at which the predetermined time elapses from the start of the self-discharge that is performed after the voltage of the electric double-layer capacitor 162 reaches the predetermined voltage (voltage threshold value) by the electric double-layer capacitor 162 being charged is smaller than the predetermined first value.

If the CPU 11 determines that the self-discharge amount of the electric double-layer capacitor 162 is equal to or larger than the discharge threshold value (Step S14; NO), the CPU 11 moves the mode determination process to Step S11 to determine the low-consumption mode as the power-supply mode of the calculator 10 for the predetermined process.

If the CPU 11 determines based on the detection result of the voltage detector 163 in Step S1 that no electric power is being supplied from the solar cell 161 (Step S2; NO), the CPU 11 moves the mode determination process to Step S12. In Step S13 in this case, the CPU 11 calculates the self-discharge profile indicating voltage change over time in the electric double-layer capacitor 162 based on the full-charge duration of the electric double-layer capacitor 162 after the voltage of the electric double-layer capacitor 162 became equal to or higher than the voltage threshold value last time by the electric double-layer capacitor 162 being charged, namely, the previous full-charge duration, the self-discharge voltage of the electric double-layer capacitor 162 measured in Step S12, and the average value of the power consumption in the calculator 10.

Next, a mode control process illustrated in FIG. 6 will be described. The mode control process is performed by the CPU 11 of the calculator 10 that is in the power-on state. By performing the mode control process, the CPU 11 sets the power-supply mode of the calculator 10 to the normal mode or the low-consumption mode and performs the predetermined process. The mode control process is formed of control steps. The CPU 11 of the calculator 10 functions as the controller in the mode control process.

In the mode control process, first, the CPU 11 performs Step A1 and Step A2 that are the same as Step S1 and Step S2 of the mode determination process, respectively. If the CPU 11 determines based on the detection result of the voltage detector 163 in Step A1 that electric power is being supplied from the solar cell 161 (Step A2; YES), the CPU 11 sets the power-supply mode of the calculator 10 to the normal mode and performs the predetermined process (Step A3) and then ends the mode control process.

If the CPU 11 determines based on the detection result of the voltage detector 163 in Step A1 that no electric power is being supplied from the solar cell 161 (Step A2; NO), the CPU 11 determines whether in the mode determination process, the normal mode has been determined as the power-supply mode of the calculator 10 for the predetermined process (Step A4). If the CPU 11 determines that in the mode determination process, the normal mode has been determined as the power-supply mode of the calculator 10 for the predetermined process (Step A4; YES), the CPU 11 moves the mode control process to Step A3.

If the CPU 11 determines that in the mode determination process, the normal mode has not been determined as the power-supply mode of the calculator 10 for the predetermined process (Step A4; NO), that is, determines that the low-consumption mode has been determined as the power-supply mode of the calculator 10, the CPU 11 sets the power-supply mode of the calculator 10 to the low-consumption mode and performs the predetermined process (Step A5) and then ends the mode control process.

As described above, the electronic apparatus (calculator 10) of the present embodiment includes the electric double-layer capacitor 162 as a battery. The electronic apparatus of the present embodiment includes the controller (CPU 11) that, in response to the electric double-layer capacitor 162 being charged in the first charging mode in which the self-discharge amount of the electric double-layer capacitor 162 per unit time after the start of its self-discharge that is performed after the voltage of the electric double-layer capacitor 162 reaches a predetermined voltage (voltage threshold value) by the electric double-layer capacitor 162 being charged is smaller than a predetermined threshold value, performs a predetermined process in the first mode (normal mode) with electric power supplied from the electric double-layer capacitor 162, and in response to the electric double-layer capacitor 162 being charged in the second charging mode in which the self-discharge amount of the electric double-layer capacitor 162 per unit time after the start of its self-discharge that is performed after the voltage of the electric double-layer capacitor 162 reaches the predetermined voltage (voltage threshold value) by the electric double-layer capacitor 162 being charged is equal to or larger than the threshold value, performs the predetermined process in the second mode (low-consumption mode) in which current consumption in performing the predetermined process is smaller than current consumption therein in the first mode with the electric power supplied from the electric double-layer capacitor 162. Therefore, even in the case where the electric double-layer capacitor 162 is charged in the second charging mode in which the full-charge duration of the electric double-layer capacitor 162 is shorter than the predetermined first time, the current consumption in the calculator 10 can be reduced by setting the power-supply mode of the calculator 10 to the low-consumption mode. This can suppress the decrease in the continuous usable time of the electronic apparatus (calculator 10). That is, even in a case where the self-discharge of an electric double-layer capacitor cannot be completely suppressed, the decrease in the continuous usable time of the electronic apparatus (calculator 10) can be suppressed.

In the electronic apparatus (calculator 10) of the present embodiment, the first charging mode is a charging mode in which the self-discharge amount of the electric double-layer capacitor 162 at a timing at which a predetermined time elapses from the start of the self-discharge that is performed after the voltage of the electric double-layer capacitor 162 reaches the predetermined voltage (voltage threshold value) by the electric double-layer capacitor 162 being charged is smaller than the predetermined first value, and the second charging mode is a charging mode in which the self-discharge amount of the electric double-layer capacitor 162 at the timing is equal to or larger than the predetermined first value. Therefore, even in the case where the electric double-layer capacitor 162 is charged in the second charging mode in which the full-charge duration of the electric double-layer capacitor 162 is shorter than the predetermined first time, the current consumption in the calculator 10 can be reduced by setting the power-supply mode of the calculator 10 to the low-consumption mode.

In the electronic apparatus (calculator 10) of the present embodiment, the predetermined process includes the calculation process or the display process on the display 13. Therefore, in the calculator 10, the current consumption by the calculation process or the current consumption by the display process on the display 13 can be reduced.

In the electronic apparatus (calculator 10) of the present embodiment, the controller (CPU 11) reduces the speed of the calculation process in the second mode to be lower than in the first mode. Therefore, in the calculator 10, the current consumption by the calculation process can be reduced.

In the electronic apparatus (calculator 10) of the present embodiment, the controller (CPU 11) performs the display process on the display 13 with a smaller number of gradation levels in the second mode than in the first mode. Therefore, in the calculator 10, the current consumption by the display process on the display 13 can be reduced.

Those described in the above embodiment are mere examples of the electronic apparatus according to the present disclosure, and the present disclosure is not limited thereto. The detailed configuration and detailed operation of each component constituting the electronic apparatus can also be changed as appropriate without departing from the scope of the present disclosure. For example, in the above embodiment, the electronic apparatus is the calculator 10, but not limited thereto, and may be another type of electronic apparatus. For example, the present disclosure may be applied to a timepiece, a radio or the like that operates by power supply from the solar cell 161 or the electric double-layer capacitor 162.

In the above, the ROM 14 is the computer-readable medium storing the programs according to the present disclosure, but the computer-readable medium is not limited thereto. The computer-readable medium may be a nonvolatile memory, such as a flash memory, a hard disk drive (HDD), or a portable recording medium, such as a CD-ROM. Further, a carrier wave is also applicable to the present disclosure as a medium that provides data of the programs via a communication line.

1. An electronic apparatus comprising:
an electric double-layer capacitor as a battery; and
at least one processor that,
in response to the electric double-layer capacitor being charged in a first charging mode in which a self-discharge amount of the electric double-layer capacitor per unit time after start of self-discharge that is performed after a voltage of the electric double-layer capacitor reaches a predetermined voltage by the electric double-layer capacitor being charged is smaller than a predetermined threshold value, performs in a first mode a predetermined process with electric power supplied from the electric double-layer capacitor, and
in response to the electric double-layer capacitor being charged in a second charging mode in which the self-discharge amount of the electric double-layer capacitor per unit time after the start of the self-discharge that is performed after the voltage of the electric double-layer capacitor reaches the predetermined voltage by the electric double-layer capacitor being charged is equal to or larger than the threshold value, performs the predetermined process in a second mode in which current consumption in performing the predetermined process is smaller than current consumption therein in the first mode with the electric power supplied from the electric double-layer capacitor.

2. The electronic apparatus according to claim 1,
wherein the first charging mode is a charging mode in which the self-discharge amount of the electric double-layer capacitor at a timing at which a predetermined time elapses from the start of the self-discharge that is performed after the voltage of the electric double-layer capacitor reaches the predetermined voltage by the electric double-layer capacitor being charged is smaller than a predetermined first value, and
wherein the second charging mode is a charging mode in which the self-discharge amount of the electric double-layer capacitor at the timing is equal to or larger than the first value.

3. The electronic apparatus according to claim 1, wherein the predetermined process includes a calculation process or a display process on a display.

4. The electronic apparatus according to claim 3, wherein the at least one processor reduces a speed of the calculation process in the second mode to be lower than in the first mode.

5. The electronic apparatus according to claim 3, wherein the at least one processor performs the display process with a smaller number of gradation levels in the second mode than in the first mode.

6. The electronic apparatus according to claim 1,
wherein the first charging mode is a charging mode in which a length of a duration for which the double-layer capacitor keeps being charged after the voltage of the electric double-layer capacitor reaches the predetermined voltage by the electric double-layer capacitor being charged is equal to or longer than a predetermined length, and
wherein the second charging mode is a charging mode in which the length of the duration is shorter than the predetermined length.

7. The electronic apparatus according to claim 1, further comprising a solar panel that generates the electric power based on incident light,
wherein the electric double-layer capacitor is charged with the electric power generated by the solar panel.

8. A control method that is performed by an electronic apparatus including an electric double-layer capacitor as a battery, the control method comprising:
in response to the electric double-layer capacitor being charged in a first charging mode in which a self-discharge amount of the electric double-layer capacitor per unit time after start of self-discharge that is performed after a voltage of the electric double-layer capacitor reaches a predetermined voltage by the electric double-layer capacitor being charged is smaller than a predetermined threshold value, performing a predetermined process in a first mode with electric power supplied from the electric double-layer capacitor; and
in response to the electric double-layer capacitor being charged in a second charging mode in which the self-discharge amount of the electric double-layer capacitor per unit time after the start of the self-discharge that is performed after the voltage of the electric double-layer capacitor reaches the predetermined voltage by the electric double-layer capacitor being charged is equal to or larger than the threshold value, performing the predetermined process in a second mode in which current consumption in performing the predetermined process is smaller than current consumption therein in the first mode with the electric power supplied from the electric double-layer capacitor.

9. The control method according to claim 8,
wherein the first charging mode is a charging mode in which the self-discharge amount of the electric double-layer capacitor at a timing at which a predetermined time elapses from the start of the self-discharge that is performed after the voltage of the electric double-layer capacitor reaches the predetermined voltage by the electric double-layer capacitor being charged is smaller than a predetermined first value, and
wherein the second charging mode is a charging mode in which the self-discharge amount of the electric double-layer capacitor at the timing is equal to or larger than the first value.

10. The control method according to claim 8, wherein the predetermined process includes a calculation process or a display process on a display.

11. The control method according to claim 10, comprising reducing a speed of the calculation process in the second mode to be lower than in the first mode.

12. The control method according to claim 10, comprising performing the display process with a smaller number of gradation levels in the second mode than in the first mode.

13. The control method according to claim 8,
wherein the first charging mode is a charging mode in which a length of a duration for which the double-layer capacitor keeps being charged after the voltage of the electric double-layer capacitor reaches the predetermined voltage by the electric double-layer capacitor being charged is equal to or longer than a predetermined length, and
wherein the second charging mode is a charging mode in which the length of the duration is shorter than the predetermined length.

14. The control method according to claim 8, wherein the electric double-layer capacitor is charged with the electric power generated by a solar panel.

15. A non-transitory computer-readable storage medium storing a program causing, of an electronic apparatus including an electric double-layer capacitor as a battery, a computer to:
in response to the electric double-layer capacitor being charged in a first charging mode in which a self-discharge amount of the electric double-layer capacitor per unit time after start of self-discharge that is performed after a voltage of the electric double-layer capacitor reaches a predetermined voltage by the electric double-layer capacitor being charged is smaller than a predetermined threshold value, perform a predetermined process in a first mode with electric power supplied from the electric double-layer capacitor, and
in response to the electric double-layer capacitor being charged in a second charging mode in which the self-discharge amount of the electric double-layer capacitor per unit time after the start of the self-discharge that is performed after the voltage of the electric double-layer capacitor reaches the predetermined voltage by the electric double-layer capacitor being charged is equal to or larger than the threshold value, perform the predetermined process in a second mode in which current consumption in performing the predetermined process is smaller than current consumption therein in the first mode with the electric power supplied from the electric double-layer capacitor.

16. The non-transitory computer-readable storage medium according to claim 15,
wherein the first charging mode is a charging mode in which the self-discharge amount of the electric double-layer capacitor at a timing at which a predetermined time elapses from the start of the self-discharge that is performed after the voltage of the electric double-layer capacitor reaches the predetermined voltage by the electric double-layer capacitor being charged is smaller than a predetermined first value, and
wherein the second charging mode is a charging mode in which the self-discharge amount of the electric double-layer capacitor at the timing is equal to or larger than the first value.

17. The non-transitory computer-readable storage medium according to claim 15, wherein the predetermined process includes a calculation process or a display process on a display.

18. The non-transitory computer-readable storage medium according to claim 17, wherein the program causes the computer to reduce a speed of the calculation process in the second mode to be lower than in the first mode.

19. The non-transitory computer-readable storage medium according to claim 17, wherein the program causes the computer to perform the display process with a smaller number of gradation levels in the second mode than in the first mode.

20. The non-transitory computer-readable storage medium according to claim 15,
wherein the first charging mode is a charging mode in which a length of a duration for which the double-layer capacitor keeps being charged after the voltage of the electric double-layer capacitor reaches the predetermined voltage by the electric double-layer capacitor being charged is equal to or longer than a predetermined length, and
wherein the second charging mode is a charging mode in which the length of the duration is shorter than the predetermined length.
